(19) United States
(12) Patent Application Publication
(10) Pub. No.: US 2010/0121887 A1
(43) Pub. Date: May 13, 2010

(54) Method for Generating a Combinatorial Annotated Image Database and an Application Thereof

(75) Inventor: David Newquist, Thousands Oaks, CA (US)

Correspondence Address: David Newquist, # 641, 2060-D E. Averida de los Arboles, Thousand Oaks, CA, 91362, US

(73) Assignee: David B. Newquist

(21) Appl. No.: 12/267,590

(22) Filed: Nov. 9, 2008

(51) Int. Cl. G06F 17/30; H04N 5/225; G06F 7/00

(52) U.S. Cl. 707/803; 348/E05.024; 707/E17.019

(57) ABSTRACT

A combinatorial annotated image set consists of photographic images of a given subject and meta data concerning the images. The meta data includes labels which may consist of several forms including photographs of objects and English phrases. A method is described herein to generate combinatorial annotated image sets having a plurality of images and labels.

### CROSS-REFERENCE TO RELATED APPLICATIONS

This application claims the benefit of U.S. provisional patent application No. 61/002,280, assigned to David B Newquist, who is also the inventor of the said application.

### INTRODUCTION TO THE INVENTION AND RELATED BACKGROUND

The invention described herein includes a novel procedure for generating and annotating an image set. Hereafter a set of images and corresponding annotations shall be referred to as an AID (Annotated Image Database). This invention yields an AID with the following property: there is one or more set comprising 2 or more images in the database associated with a set of labels and other annotations. Any label in the label set is characteristic of any of the images in the image set. Therefore, for a given image set with N images and M labels, any image can be combined with any annotation in N*M unique image-label pairs. Hereafter, such a set will be referred to as a combinatorial annotated image set (CAIS). Hereafter, an AID that has one or more CAIS shall be referred to as a combinatorial annotated image database (CAID). An area of novelty in this invention is the specification of techniques for generating CAISs in a CAID. These novel techniques allow large CAIDs to be created quickly.

Most humans have a facility to generate labels for images and a facility to match characteristic labels to corresponding images. Using the method specified herein, it is possible for a human, H1, to examine a single image from a special set and produce one or more labels that apply to all images in the set.

One relevant application of an AID is an Automated System for Discerning Computers from Humans (ASDCH). In an ASDCH, an agent—either a computer or a human—can submit a request to the system to take a test. The agent submits a response to the ASDCH after taking the test, and the ASDCH attempts to discern computer agents from human agents. Such systems have been described in prior art [1].

An example of an ASDCH that uses an AID (hereafter referred to as an ASDCHUAID) is ESP-PIX [2]. An ESP-PIX test consists of several images selected from the database that share a common label. A label in the ESP-PIX system is a single word. In addition to the images, the test also consists of a list of several dozen words. One of words in this list is the label that the images have in common. The agent response consists of one of the words from list. If the agent responds with the common label, the system discerns the agent is a human, else a computer.

The discernment effectiveness of an ASDCHUAID relies on not only the ability of human agents to correctly match a characteristic label to an image, but also on the inability at present of computer agents to make the same match.

Presented for this first time in this application is a specification of a particular web-based ASDCH that uses a CAID. Such a system shall hereafter be referred to as an ASDCHUCAID.

### BRIEF DESCRIPTIONS OF THE DRAWINGS

FIG. 1: Example of images in a Combinatorial Annotated Image Set

FIG. 2: Example of images in a Combinatorial Annotated Image Set

FIG. 3: A PhotoVer test with three challenges

FIG. 4: An image that consists of a square with 3 sections of color. In the “Detailed Description of the Invention” section a label generator is described for this image.

### DETAILED DESCRIPTION OF THE INVENTION

Terminology:

AID (Annotated Image Database): a set of images and corresponding annotations.

CAIS (Combinatorial Annotated Image Set): a given image set with N images and M labels, any image can be combined with any annotation in N*M unique image-label pairs.

CAID (Combinatorial Annotated Image Database): one or more CAISs.

Strong Descriptor: a word, stem word, n-gram or feature taken from a CAIS label

Weak Descriptor: a word, stem word, n-gram or feature that describes a non-prominent feature of an image. A weak descriptor for an image cannot also be a strong descriptor.

LGA (Label Generation Algorithm): used to generate labels for a CAIS ASDCH (Automated System for Discerning Computers from Humans)

ASDCHUAID: ASDCH using an AID

ASDCHUCAID: ASDCH using a CAID

In the method herein of creating a CAID, one or more CAISs are created and added to the CAID.

To create a CAIS, a set of closely related images must be obtained. Several techniques are specified herein.

A set of related images can be obtained by capturing a video that features a prominent subject from start to finish. By definition, a video consists of a sequence of images, which can be extracted from the video. Two consecutive images in the sequence will be distinct if the light stream entering the recording devices has changed between frame captures, or if the recording device undergoes state change between frame captures.

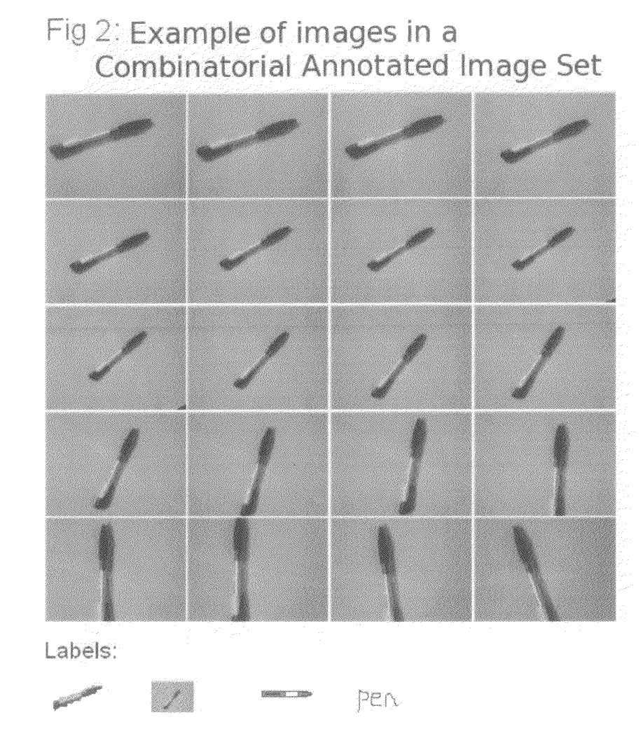

An example of CAIS suitable images that have been generated from a video recording device is shown in FIG. 2. Nine corresponding English labels might include: (1) pen, (2) green pen, (3) green and white pen, (4) pen on a whitish background, (5) green pen on a whitish background, (6) pen on a grayish background, (7) pen on a greyish background, (8) gr_e_een.PEn, (9) used for writing. Corresponding strong descriptors include: (1) pen, (2) green, (3) white, (4) whitish, (5) background, (6) gray, (7) grayish, (8) grey, (9) greyish, (10) greeen, (11) used, (12) writing. Corresponding weak descriptors might include: (1) paper, (2) line, (3) carpet, (4) shadow. Since there are 9 English labels and 4 graphical labels (see FIG. 2. for graphical labels), there are 20 images×13 lables=260 unique image label pairs for this CAIS.

There are several techniques to ensure that 2 or more images in a video sequence will be distinct. One technique is to engage a zoom-in or zoom-out feature of the recording device. Another technique is to move the recording device relative to the subject. Another technique is to manipulate the sources of light reflecting off the subject. Another technique is to choose a subject that is in motion. Another technique is to choose a subject that is changing state such that it reflects or emits light differently. It may be possible to use other recording techniques to ensure 2 or more images in a video sequence are distinct.

A set of related images can also be obtained by creating a computer program to generate a sequence of images featuring a prominent subject from start to finish. Such a program starts by rendering one or more objects in the first image in the sequence. The objects may be chosen at random from a database. To produce the next image in the sequence, the program changes the position of one or more objects in the first image and changes the coloring of one or more objects or the background such that the prominent subject is still recognizable. The computer checks to see that each newly created image is distinct, else it tries a different change to the previous image.

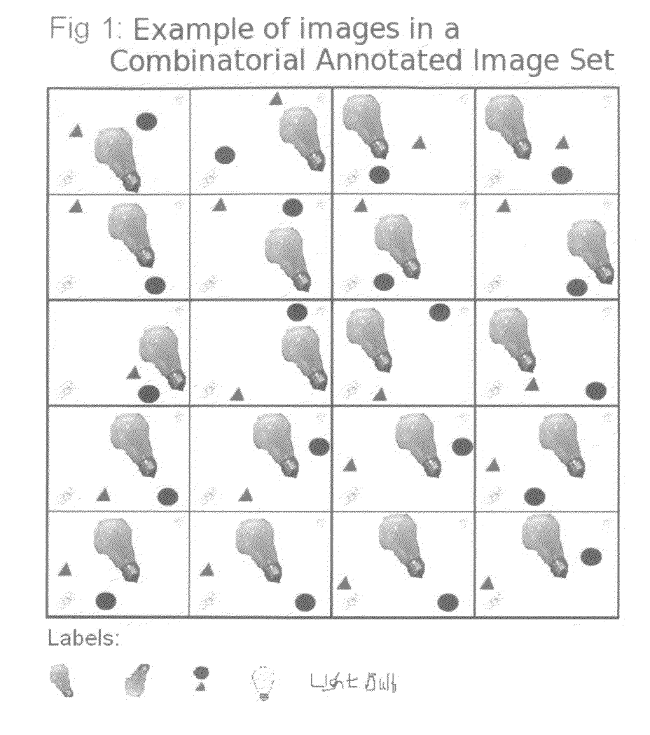

An example of CAIS images created using a computer program is shown in FIG. 1. Twelve corresponding English labels might include: (1) lightbulb, (2) “red triangle, blue circle and lightbulb”, (3) lightbulb and shapes, (4) shapes and lightbulb, (5) “red triangle, lightbulb and blue circle”, (6) “blue circle, lightbulb and red triangle”, (7) “blue circle, red triangle and lightbulb”, (8) “lightbulb, red triangle and blue cirlce”, (9) “lightbulb, blue circle and red triangle”, (10) “litebulb (11) leightbolb (12) li_ght_Bul-b”. The corresponding strong-descriptors include (1) lightbulb, (2) red, (3) blue, (4) triangle, (5) circle, (6) litebulb, (7) leightbolb, (8) li_gh_Bul-b. Seven corresponding weak descriptors might include: (1) smudge, (2) smudges, (3) shine, (4) reflection, (5) smudge, (6) pixels, (7) jagged.

Once a set of related images is obtained, the set can be associated with a set of labels. This association may be performed by a human examining a single, arbitrary image from the set. A label may be selected if it is reasonable to assume another human examining any image from the set would generally agree that the label is characteristic of that particular image.

A label might take one the following forms: a word, a phrase, a symbol, a sound, a video, an image, or a smell. A label in this context is not limited to these forms. Any image in the image set may serve as a label for any other image.

A set of “strong descriptors” (see terminology) can be obtained from the set of labels and associated with an image set. If the labels are phrases in English, the Porter Stemming Algorithm [3] might be used to produce the set of strong descriptors. “Weak descriptors” can be obtained and by examining 1 or more images from the set. A weak descriptor cannot also be a strong descriptor. A weak descriptor generally describes a minor aspect of the image set.

The labels may be generated from a label generation algorithm (LGA). An LGA may be implemented as a computer program. An LGA might be constructed to only generate labels for a particular image set. In contrast, an LGA might be capable of generating labels for an arbitrary image. Such an LGA might utilize an image parser to extract features from the images to be used as labels. It may be desirable for an LGA to generate a multitude of labels, especially if it is desirable to produce a CAIS with a multitude of distinct image, label pairs.

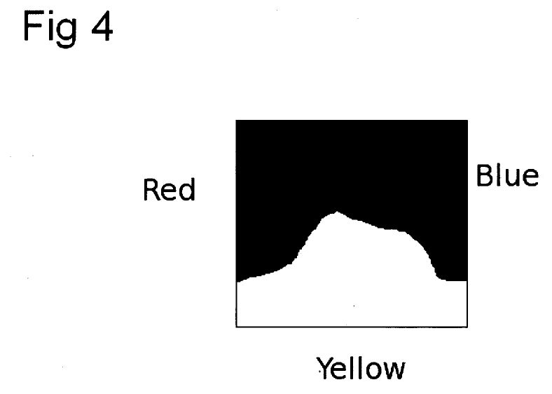

The following pseudo code specifies an LGA that generates English language labels for the image in FIG. 4. Note that a line that begins with a ‘#’ character is a comment.

```
#Let ’colors’ be an array with 3 string elements
colors = (‘red’, ‘blue’, ‘yellow’)
#In the next line, we pass the ’colors’ array as an input to a subroutine
called ’getPermutations’.
#getPermutations will return an array. Each element of the returned array
#is also an array. Each array element of the return array is a permutation
of the elements of the
#input array. If the input array has N elements, the return array will
#contain N-factorial elements comprising all the permutations of the input
array.
colorPermutations = getPermutations(colors)
shapeNames = ( ‘square’, ‘box’, ‘quadrilateral’ )
connectorSetA = ( ‘ ’, ‘ sections in a ’ )
connectorSetB = (‘ that is ’, ‘ having ’, ‘: ’)
foreach permutation in colorPermutations:
  foreach shapeName in shapeNames:
    foreach connector in connectorSetA:
        #A ‘.’ character represents a string concatenation operation
        #‘\n’ is a new line character
        print permutation[0] .‘, ’ .permutation[1] .‘ and ’ .permutation[2]
            .connector .shapeName .‘\n’
    foreach connector in connectorSetB:
        print shapeName .connector .permutation[0] .‘, ’ .permutation[1]
            .‘ and ’ .permutation[2] .“\n”
```

If this LGA is implemented in a computer language, compiled and run, it will produce the following 90 labels.
red, blue and yellow square
red, blue and yellow sections in a square
red, blue and yellow box
red, blue and yellow sections in a box
red, blue and yellow quadrilateral
red, blue and yellow sections in a quadrilateral
red, yellow and blue square
red, yellow and blue sections in a square
red, yellow and blue box
red, yellow and blue sections in a box
red, yellow and blue quadrilateral
red, yellow and blue sections in a quadrilateral
blue, red and yellow square
blue, red and yellow sections in a square
blue, red and yellow box
blue, red and yellow sections in a box
blue, red and yellow quadrilateral
blue, red and yellow sections in a quadrilateral
blue, yellow and red square
blue, yellow and red sections in a square
blue, yellow and red box
blue, yellow and red sections in a box
blue, yellow and red quadrilateral
blue, yellow and red sections in a quadrilateral
yellow, red and blue square
yellow, red and blue sections in a square
yellow, red and blue box
yellow, red and blue sections in a box
yellow, red and blue quadrilateral
yellow, red and blue sections in a quadrilateral
yellow, blue and red square
yellow, blue and red sections in a square
yellow, blue and red box
yellow, blue and red sections in a box
yellow, blue and red quadrilateral
yellow, blue and red sections in a quadrilateral
square that is red, blue and yellow
square having red, blue and yellow
square: red, blue and yellow
box that is red, blue and yellow
box having red, blue and yellow
box: red, blue and yellow
quadrilateral that is red, blue and yellow
quadrilateral having red, blue and yellow
quadrilateral: red, blue and yellow
square that is red, yellow and blue
square having red, yellow and blue
square: red, yellow and blue
box that is red, yellow and blue
box having red, yellow and blue
box: red, yellow and blue
quadrilateral that is red, yellow and blue
quadrilateral having red, yellow and blue
quadrilateral: red, yellow and blue
square that is blue, red and yellow
square having blue, red and yellow
square: blue, red and yellow
box that is blue, red and yellow
box having blue, red and yellow
box: blue, red and yellow
quadrilateral that is blue, red and yellow
quadrilateral having blue, red and yellow
quadrilateral: blue, red and yellow
square that is blue, yellow and red
square having blue, yellow and red
square: blue, yellow and red
box that is blue, yellow and red
box having blue, yellow and red
box: blue, yellow and red
quadrilateral that is blue, yellow and red
quadrilateral having blue, yellow and red
quadrilateral: blue, yellow and red
square that is yellow, red and blue
square having yellow, red and blue
square: yellow, red and blue
box that is yellow, red and blue
box having yellow, red and blue
box: yellow, red and blue
quadrilateral that is yellow, red and blue
quadrilateral having yellow, red and blue
quadrilateral: yellow, red and blue
square that is yellow, blue and red
square having yellow, blue and red
square: yellow, blue and red
box that is yellow, blue and red
box having yellow, blue and red
box: yellow, blue and red
quadrilateral that is yellow, blue and red
quadrilateral having yellow, blue and red
quadrilateral: yellow, blue and red

This particular LGA is combinatorially explosive. If the number of elements in the colors array is N, then the algorithm produces a list of labels whose number is a multiple of N-factorial. If we add another element to the color array in the pseudocode and change nothing else, then it will yield 360 labels. If we add yet another color, the yield will be 1800 labels.

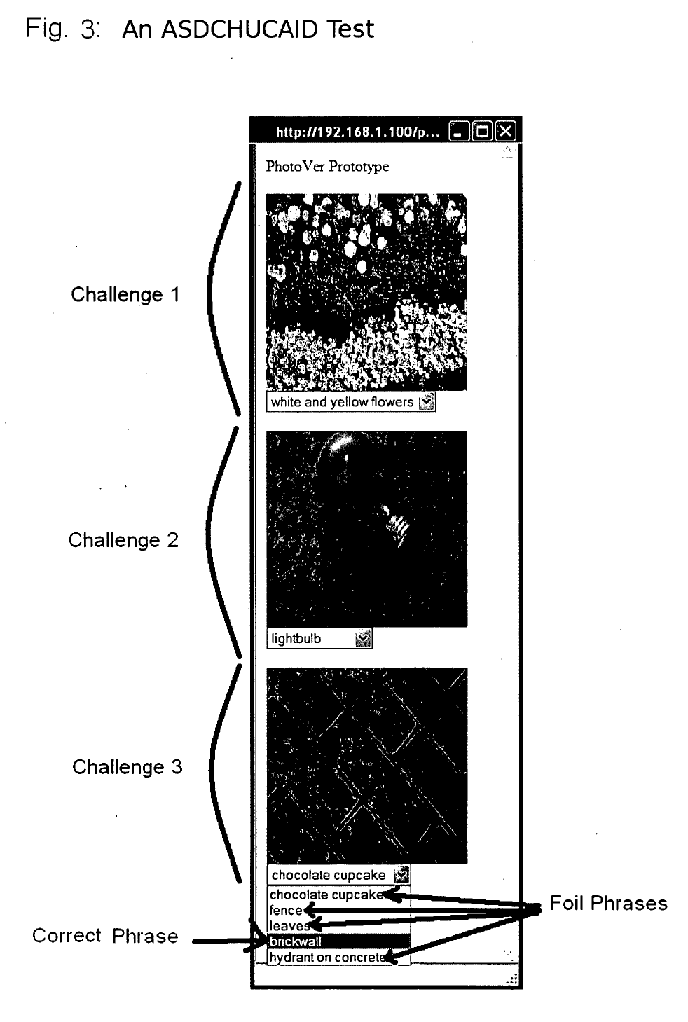

As mentioned previously, one application of a CAID is an ASDCHUCAID. An ASDCHUCAID with novel characteristics is described herein. A test issued by this ASDCHUCAID to an agent consists of N challenges. An agent's response to the test consists of N answers corresponding to each challenge. If the response contains M or more correct answers, then the system designates the response as ‘pass’ else ‘fail’. Based on the response designation, the agent may be granted or denied access to a resource in a system that is utilizing the ASDCHUCAID. A sample ASDCHUCAID test is shown in FIG. 3.

A challenge in this system consists of an image from the CAID, 1 label from the label set associated with the image's CAIS, and 1 or more “foil labels”. A foil label is not a member of the label set associated with the image's CAIS. An agent's answer to a challenge consists of a selection of one of the labels. A challenge answer is correct if the agent's selection is the label corresponding to the image.

In one variation of the system, a foil label can not contain any of the strong descriptors associated with the image. In another variation of the system, a foil label can not contain any strong or weak descriptors associated with the image. Such restrictions are intended to reduce the likelihood of the system choosing a foil label that a human agent will erroneously select as an answer to the challenge.

In one variation of the system, the system tallies the number of pass and fail test responses for all ip addresses (or some other communication address or characteristic) that have requested 1 or more tests. If the number of pass or fail responses satisfies a certain condition (e.g. number of fail responses is >3), then the system ignores all future test requests from that ip address.

In one variation of the system, one or more of the challenges is an advertisement.

In conclusion, a method for generating a “combinatorial annotated image database” (CAID) has been specified. The method provides 2 techniques—using a video recorder and using a computer program—for generating images suitable for a “combinatorial annotated image set” (CAIS) and several techniques for labeling a CAIS—including the use of a “label generation algorithm” (LGA). Examples of 2 CAISs are provided. Finally, an application of a CAID is described: an “automated system for discerning computers from humans using a CAID” (ASDCHUCAID) with novel characteristics.

### REFERENCES

[1] Von Ahn, Luis et al., Telling Computers and Humans Apart Automatically, Communications of the ACM, February 2004/Vol. 47, No. 2

[2] Von Ahn, Luis et al., ESP-PIX

[3] Fowler, Martin, The Porter Stemming Algorithm

What is claimed is:

1. A method of generating a combinatorial annotated image set (CAIS) comprising 1 or more of the following methods: the use of a machine to generate a subset of the related images of the CAIS; and the use of a machine to generate a subset of the labels of the CAIS.

2. The CAIS generating method of claim 1, wherein a video recording device is used to generate the related image subset.

3. The CAIS generating method of claim 1, wherein a computer program generates the related image subset.

4. The CAIS generating method of claim 1, wherein a video recording device is used to generate the label subset.

5. The CAIS generating method of claim 1, wherein a computer program generates the label subset.

6. The CAIS generating method of claim 1, wherein a set of strong descriptors is derived from the label set and associated with the CAIS.

7. The CAIS generating method of claim 6, wherein a Word stemmer is used to derive strong descriptors from any word based labels.

8. The CAIS generating method of claim 6, wherein a set of weak descriptors is derived from the image set and associated with the CAIS.

9. An automated system for discerning computers from humans (ASDCH) comprising the use of a combinatorial annotated image database (CAID), wherein said ASDCH can provide a test to a test taker upon request of the test taker, wherein said test consists of one or more challenges, wherein a said challenge comprises: a single image belonging to a CAIS; and 2 or more labels, wherein one and only one of the said labels is taken from the label set belonging to the said CAIS; wherein said ASDCH examines the test taker's test response, wherein a test response consists of a response to each challenge, wherein said ASDCH concludes a test taker's test response is correct if and only if each challenge response is correct, wherein a correct challenge response consists of the label corresponding with the test image.

10. The ASDCH of claim 9, wherein regarding each test challenge none of the foil labels contain or feature a strong descriptor belonging to the CAIS for that test challenge.

11. The ASDCH of claim 9, wherein regarding each test challenge none of the foil labels contain or feature: a strong descriptor belonging to the CAIS for that test challenge; or a weak descriptor belonging to the CAIS for that test challenge.
